(19) United States
(12) Patent Application Publication
(10) Pub. No.: US 2024/0393604 A1
(43) Pub. Date: Nov. 28, 2024

(54) VARIABLE DIVERGENCE LASER FOR DYNAMIC FOCUS ADJUSTMENT

(71) Applicant: nLIGHT, Inc., Camas, WA (US)

(72) Inventor: Brian M. VICTOR, Camas, WA (US)

(21) Appl. No.: 18/672,866

(22) Filed: May 23, 2024

Related U.S. Application Data
(60) Provisional application No. 63/504,151, filed on May 24, 2023.

(51) Int. Cl. G02B 27/09; B23K 26/06; G02B 19/00

(52) U.S. Cl. CPC G02B 27/0933; B23K 26/0665; G02B 19/0009; G02B 19/0047; G02B 27/0994

(57) ABSTRACT

A laser processing system has a laser source and a divergence-tuning beam characteristic conditioner configured to, in response to a control input, repetitively change a variable divergence laser beam between a first divergence and a second divergence that is different from the first divergence. The system also includes a process head having a collimating lens and a focusing lens. And the system includes a delivery fiber coupled to the divergence-tuning beam characteristic conditioner for guiding the variable divergence laser beam and launching it to the process head. The collimating lens is configured to receive the variable divergence laser beam and direct it as an intermediate beam to the focusing lens to focus the intermediate beam toward the workpiece at a first depth corresponding to the first divergence and at a second depth corresponding to the second divergence.

### RELATED APPLICATIONS

This US Non-Provisional patent application relies for priority on U.S. Provisional Patent Application Ser. No. 63/504,151, entitled “VARIABLE DIVERGENCE LASER FOR DYNAMIC FOCUS ADJUSTMENT,” filed May 24, 2023, the content of which is hereby incorporated by reference in its entirety.

### TECHNICAL FIELD

This disclosure relates generally to fiber lasers and fiber-coupled lasers. In particular, this disclosure relates to adjusting beam characteristics with an optical fiber for generating a variable beam that is used in material processing.

### BACKGROUND INFORMATION

The applicant for the present application, nLIGHT, Inc. of Camas, Washington, has developed all-fiber solutions for providing variable beam characteristics. These fiber structures are employed in various high-power laser processing applications (e.g., deposition, welding, cutting, scribing, additive manufacturing, or other applications), some of which are the subject of the following nLIGHT patents describing technology developed by Brian M. Victor: U.S. Pat. Nos. 10,668,567; 10,646,963; 10,739,621; and 10,656,330. Some portions of these patents are summarized as follows. For instance, with reference to FIG. 29 of the '567 patent, a multi-operation optical beam delivery device facilitates different laser process operations by modification of beam characteristics. FIGS. 30-31C of the '963 patent and related passages describe techniques for changing beam characteristics of a beam delivery device so as to control a melt pool property (e.g., a signature or a trait) or a keyhole cavity property. FIGS. 31-33 of the '621 patent and related passages describe a laser system for brazing or welding, in which the beam characteristics are modified to accommodate different processes. FIGS. 30-34B of the '330 patent and related passages describe how the beam characteristics can be modified for controlling solidification.

Some attempts at controlling a beam using free-space optics have been made for metal cutting applications. For example, attempts at cutting of a material have entailed rapidly moving a lens up or down inside a cutting head, using a free-space optic assembly that converts the beam into multiple static coaxial foci, and using a phased array solution to achieve a dynamic focus effect from multiple laser sources.

### SUMMARY OF THE DISCLOSURE

Disclosed is a laser processing system for laser processing a workpiece (e.g., a metal component or other material such as glass, ceramic, or polymer material). In the system, a fiber assembly includes a laser source and a divergence-tuning beam characteristic conditioner configured to, in response to a control input, repetitively change a variable divergence laser beam between a first divergence and a second divergence that is different from the first divergence. A process head has a collimating lens and a focusing lens. A delivery fiber is coupled to the divergence-tuning beam characteristic conditioner for guiding the variable divergence laser beam and launching it to the process head, in which the collimating lens is configured to receive the variable divergence laser beam and direct it as an intermediate beam to the focusing lens. The focusing lens is configured to focus the intermediate beam toward the workpiece at a first depth corresponding to the first divergence and at a second depth corresponding to the second divergence so that a focused location reciprocates vertically in a melt pool of the workpiece.

The laser processing system may also include the divergence-tuning beam characteristic conditioner being configured to repetitively change the variable divergence laser beam by oscillating between the first and second divergences.

The laser processing system may also include the divergence-tuning beam characteristic conditioner being configured to repetitively change the variable divergence laser beam by discrete switching between the first and second divergences.

The laser processing system may also include the divergence-tuning beam characteristic conditioner being further configured to repetitively change the variable divergence laser beam between the first divergence and the second divergence utilizing a constant beam power between the first divergence and the second divergence.

The laser processing system may also include the divergence-tuning beam characteristic conditioner being further configured to repeatedly change the variable divergence laser beam between the first divergence and the second divergence by, selectively, using one or more frequencies in a first frequency range for welding metal or in a second frequency range for cutting metal. The laser processing system may also include the one or more frequencies of the second frequency range being at higher frequencies than the one or more frequencies of the first frequency range. The laser processing system may also the first frequency range including frequencies of approximately 10 Hertz to 1,000 Hertz, and the second frequency range including frequencies of approximately 1,000 Hertz to 5,000 Hertz.

The laser processing system may also include the divergence-tuning beam characteristic conditioner having a first and second length of fiber having different RIPs.

The laser processing system may also include a mandrel for perturbing the divergence-tuning beam characteristic conditioner. The laser processing system may also include a micro-bend section for perturbing the divergence-tuning beam characteristic conditioner.

The disclosed techniques provide the following advantages. A time averaged beam waist is deeper/longer than a static beam. Varying the location of the focus enables deeper penetration welding with a small spot size. It also improves keyhole stability during vaporization welding. Thicker metal cutting is capable without decreased speed for fusion cutting thick plates (N₂, air, Argon, etc.). There is improved edge quality for cutting thick plate with either fusion cutting (N₂, air, Argon, etc.) or exothermic cutting (O₂). The techniques provide for altering working distance from simple, fixed optics at high speeds for any process. The disclosed techniques are believed to be faster and less expensive than mechanics needed to accelerate and move lens(es) within the head at similar speeds.

Other technical features may be readily apparent to one skilled in the art from the following figures, description, and claims. The foregoing and other objects, features, and advantages will become more apparent from the following detailed description, which proceeds with reference to the accompanying figures, which may not be drawn to scale.

### BRIEF DESCRIPTION OF THE DRAWINGS

To easily identify the discussion of any particular element or act, the most significant digit or digits in a reference number refer to the figure number in which that element is first introduced.

FIG. 1 is an annotated sequence of longitudinal cross sections during a conventional laser welding process, according to the prior art.

FIG. 2 is an image of a metallic material after a conventional laser cutting process utilizing a static focus of the laser beam.

FIG. 3 is an image of another metallic material after a laser cutting process having a dynamic focus adjustment of a laser beam, in accordance with examples described herein.

FIG. 4 is a block diagram of a laser processing system for generating variable divergence laser beam provided to a process head that produces a dynamic focus adjustment, in accordance with examples described herein.

FIG. 5 is a time dependent graph of displacement with dwell at different depths/locations in the material for each cutting and welding.

FIG. 6 is an isometric view of a workpiece being cut during a laser process, according to one embodiment.

FIG. 7 is an isometric view of a workpiece being welded during a laser process, according to one embodiment.

FIG. 8 is a side view of an optical beam delivery device including a bendable ¼ pitch length of GRIN fiber, a step-index length of fiber, and a straight GRIN length of fiber, according to one embodiment.

FIG. 9 is a side view of an optical beam delivery device including multiple lengths of optical fiber, according to another embodiment.

FIG. 10 is a side view of an optical beam delivery device including multiple lengths of optical fiber, according to another embodiment.

FIG. 11 is a flowchart of a process, according to one embodiment

### DETAILED DESCRIPTION OF EMBODIMENTS

### Introduction

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatuses, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatuses are not limited to any specific aspect or feature or combinations thereof, nor do the disclosed systems, methods, and apparatuses require that any one or more specific advantages be present, or problems be solved. Any theories of operation are to facilitate explanation, but the disclosed systems, methods, and apparatuses are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatuses can be used in conjunction with other systems, methods, and apparatuses. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by skilled persons.

In some examples, values, procedures, or apparatuses are referred to as “lowest,” “best,” “minimum,” or the like. It will be appreciated that such descriptions are intended to indicate that a selection among many used functional alternatives can be made, and such selections need not be better, smaller, or otherwise preferable to other selections. Examples are described with reference to directions indicated as “above,” “below,” “upper,” “lower,” and the like. These terms are used for convenient description, but do not imply any particular spatial orientation. Moreover, in the following examples, laser components and assemblies are described at a high level of abstraction and do not include a complete description of all mechanical, electrical, and optical elements necessary for operation.

As used herein, optical radiation refers to electromagnetic radiation at wavelengths of between about 200 nm and 10 μm, and typically between about 200 nm and 2 μm. Examples based on available laser diode and fiber laser sources and optical fibers generally are associated with wavelengths of between about 800 nm and 2,000 nm. In some examples, propagating optical radiation is referred to as one or more beams having diameters, asymmetric fast and slow axes, beam cross-sectional areas, and beam divergences that can depend on beam wavelength and the optical systems used for beam shaping. For convenience, optical radiation is referred to as light or beams in some examples and need not be at visible wavelengths. Forward-propagating light or optical beams or beam portions refer to light, beams, or beam portions that propagate in a direction of normal emission. Backward-propagating light or optical beams or beam portions refer to light, beams, or beam portions that propagate in an opposite direction of normal emission.

### Component Overview

To understand the characteristics of embodiments described in the present disclosure, it is helpful to first understand the underlying components and physical phenomena exploited with the components. Accordingly, the following paragraphs summarize various designs and properties of optical fibers and lenses.

Optical fibers: An optical fiber is a thin, flexible strand of material (typically glass) that guides light within a core that is surrounded by a cladding. The core has a higher refractive index than the cladding, causing light to be guided by total internal reflection. The refractive index profile (RIP), i.e., the refractive index as a function of position transverse to the fiber axis, determines many of the important properties of the fiber. Many but not all fibers are cylindrically symmetric (i.e., the index is independent of azimuthal angle about the fiber axis). Optical fibers may have circular, square, rectangular, polygonal, oval, elliptical, or other cross-sections. In some embodiments, the core and claddings are approximately concentric. In other examples, one or more of the cores and claddings are decentered, and in some examples, core and cladding orientation and/or displacement vary along a waveguide length.

Optical fibers are typically formed of silica (glass), and dopants are added to increase or decrease the refractive index. Dopant concentrations are varied transversely to generate the desired RIP. In some examples, fibers or other waveguides are made of other materials such as fluorozirconates, fluoroaluminates, fluoride or phosphate glasses, chalcogenide glasses, or crystalline materials such as sapphire, depending on wavelengths and other properties of interest. Refractive indices of silica and fluoride glasses are typically about 1.5, and refractive indices of other materials such as chalcogenides can be 3 or more. In still other examples, optical fibers can be formed in part or completely of plastics (polymers).

In some examples, a doped waveguide core such as a fiber core provides optical gain in response to pumping. In the examples disclosed herein, a waveguide core such as an optical fiber core is doped with one or more rare-earth elements such as Nd, Yb, Ho, Er, Tm, or other active dopants or combinations thereof. Such actively doped cores can provide optical gain in response to optical pumping. As disclosed below, waveguides having such active dopants can be used to form optical amplifiers, or, if provided with suitable optical feedback such as reflective layers, mirrors, Bragg gratings, or other feedback mechanisms, such waveguides can generate laser emissions. Optical pump radiation can be arranged to co-propagate and/or counter-propagate in the waveguide with respect to a propagation direction of an emitted laser beam or an amplified beam.

Step-index fibers: The most common RIP is known as “step index,” in which the core has a uniform index and is surrounded by the cladding with a uniform (lower) index. In a step-index fiber, light launched into the fiber core in a given location tends to spread radially and azimuthally to fill the core, i.e., the core does not preserve spatial information about the location of the launched beam. It is known that light rays launched at a particular angle with respect to the fiber axis tend to exit the fiber core at the same angle (in a cone because of azimuthal scrambling), i.e., step-index fibers typically preserve angular information. In particular, the preservation of the launch angle at the output of the step-index fiber (i.e., the far-field divergence profile) is a property leveraged by embodiments of this disclosure. (Note that the terms far- and near-field intensity distribution mean, respectively, an angular intensity distribution (with respect to the optical axis) and a transverse spatial intensity distribution.) Various effects can cause imperfect preservation of the launch angle (e.g., causing higher divergence for the output than the input rays), and multiple studies have investigated methods to minimize this effect.

GRIN fibers: Some fibers have a non-uniform RIP in the core and (less often) in the cladding. A common, non-uniform core RIP is known as “graded index” or “GRIN,” in which the index value decreases monotonically from the center of the core to the cladding. In many cases, the GRIN profile is parabolic. The size of a beam coupled into a parabolic GRIN fiber may oscillate periodically as the beam propagates along the fiber, with the oscillation period known as the “pitch” of the fiber. A parabolic GRIN fiber with an appropriate length can act as a lens that focuses or collimates a beam. This property is also used in free-space GRIN lenses, i.e., it is not limited to fibers.

Multi-clad fibers: Another example of a non-uniform RIP is a fiber with multiple claddings (“double-clad fiber,” “triple-clad fiber,” etc.). As with other non-uniform RIPs, propagation of light in a multi-clad fiber depends on the specific RIP and the launch or coupling conditions. Light launched into a given region will spread into all adjacent higher-index regions, but it may not spread into all adjacent lower-index regions (which act as a cladding for the higher-index region).

Multi-core fibers: Some fibers have multiple cores, i.e., multiple high-index guiding regions separated by surrounding low-index regions. The cores can have different sizes and shapes. A ring fiber, described above, is an example of a multi-core fiber. Light launched into a given core of a multi-core fiber will typically spread out to fill that core (as in a fiber with a single core) but will not spread into the other cores because the surrounding low-index region (cladding) prevents propagation between the cores. Multi-core fibers can be used to generate different beam shapes (i.e., near-field spatial profiles) by coupling different powers into each core. In comparison to standard fibers (especially step-index fibers), multi-core fibers have several disadvantages: (1) Multi-core fibers are generally more expensive than standard fibers. (2) The low-index regions separating the guiding regions generate highly divergent light if a portion of the beam is coupled into them. The downstream optics are designed to accommodate this excess divergence, which typically adds cost, complexity, and/or optical loss (reduced efficiency). If not properly managed, the excess divergence can cause overheating or damage of the optics or other components. (3) The dimensions of the guiding regions are fixed when the fiber is manufactured. The beam dimensions thus cannot be continuously varied (although the power in each region can be continuously varied). Furthermore, if an application prefers different dimensions (e.g., a larger diameter ring), a new multi-core fiber must be fabricated, which can lead to a proliferation of product designs (which complicates and adds cost to manufacturing). (4) Splicing of multi-core fibers is complicated by the need to align multiple guiding regions, which each have fabrication tolerances. Achieving the desired splicing performance can require excessively tight fiber tolerances (increasing cost), low splice yields, and/or performance degradation upon splicing (e.g., from coupling light into the low-index regions, resulting in increased divergence).

Note that the above discussion of the different types of optical fibers primarily pertains to multimode fibers, in which the ray picture of light propagation is accurate. Single-mode or near-single-mode fibers introduce other phenomena that are less relevant to the embodiments described in this disclosure.

Lenses: Lenses are ubiquitous in optical systems. A lens is conventionally thought of as a piece of glass with one or both surfaces curved, and the angle of propagation of a light ray is influenced by refraction at the surfaces. Other implementations of lenses are possible, including a GRIN lens (as mentioned above) in which the RIP of the material varies with radial position (rather than employing curved surfaces). The end of a fiber or of an end cap attached to a fiber can have a curved surface to function as a lens. A design property of a lens is its focal length. A collimated input beam is focused to a point one focal length away from the lens (in the ray picture). Similarly, a point source located one focal length away from a lens is collimated at the lens output. Stated more generally, a lens maps between position and angle, i.e., a lens converts the angle of a ray at the input focal plane to position at the output focal plane, and it converts the input position of a ray at the input focal plane to angle at the output focal plane.

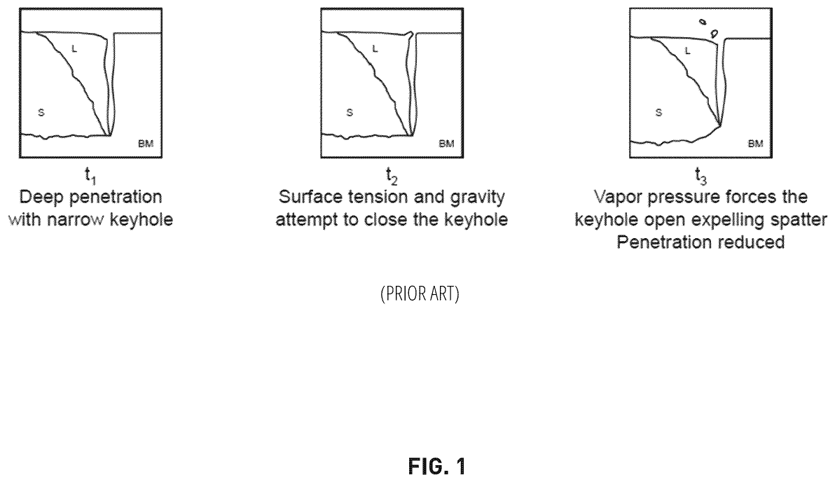

FIG. 1 shows an example of keyhole instability fluctuations in a conventional chaotic laser welding process. The weld is formed by melting parts of base metal with optional filler material. A high-intensity beam (not shown) vaporizes liquid metal at the bottom of a cavity, called a keyhole. As the vapor escapes, creating this keyhole, the depression remains narrow due to its liquid walls which are constantly attempting to close due to gravity and surface tension. Any fluctuation in the material or the process conditions can cause the keyhole to momentarily collapse. The encroaching liquid metal prevents the laser from reaching the solid material. Consequently, the laser cannot effectively continue welding the deeper material. The keyhole can then restart, for instance, at t4 (not shown), reestablishing penetration without keyhole occlusion. However, the keyhole may collapse once more. This dynamic instability during the process is undesirable, as it affects penetration and leads to spatter (i.e., ejected metal particles).

To avoid this chaotic instability, the focus position can be dynamically adjusted to maintain a minimal disturbance of the liquid walls of the keyhole. Surface tension effects of the keyhole walls can be controlled by keeping the geometry of the keyhole in a dynamic state. When the keyhole is opening or closing the rate of change prevents the liquid metal from chaotically trying to collapse. By dynamically adjusting the focus position, the keyhole can be designed to minimally increase and decrease in size and depth. This dynamic adjustment of the keyhole controls the liquid metal flow and prevents the liquid material from reaching a steady state of chaotic instability.

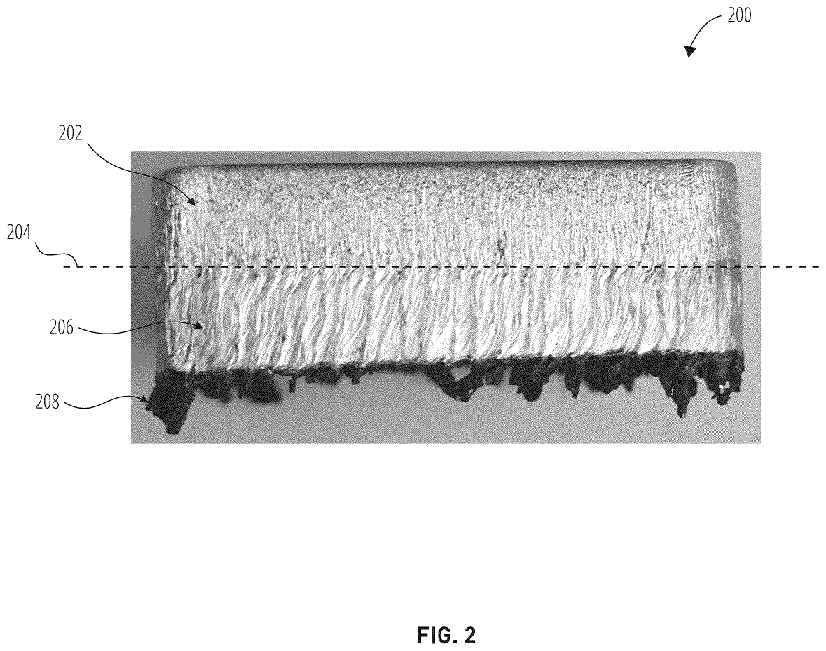

FIG. 2 shows a metal workpiece material 200 after a conventional laser cutting process. In this example, metal workpiece material 200 is about 12 mm thick and has been cut using a 4 kW laser beam having a static focus. The cutting speed was about 0.5-0.8 m/min with focus of −8 mm into the material (measured from the top surface). In general, the focus position for inert cutting is typically beyond half-way through the thickness of the material or near the surface of the material. The focus position for exothermic cutting is typically at the surface or above the material surface.

An inefficient cutting process occurs when the cut kerf is unstable or too narrow preventing clean ejection of the molten metal during cutting. As a result, an upper portion 202 (i.e., the cut portion above a mid-thickness line 204) is relatively smooth whereas a lower portion 206 is relatively rough. A bottom side includes a significant amount of dross 208.

The present inventor recognized, however, that if the focus location of the beam is reciprocated within the cut kerf, then it is possible to widen the kerf and more easily eject the liquid metal during cutting. The wider diameters of the beam at the extents of the waist provide more melting of the sidewalls of the kerf. This additional material removal can help open the cut kerf to more easily allow ejection by the vaporization and pressurized assist gas used in cutting process. To avoid overheating the material, oscillating the position of the focus within the material thickness reduces the interaction time at each position along the cut front.

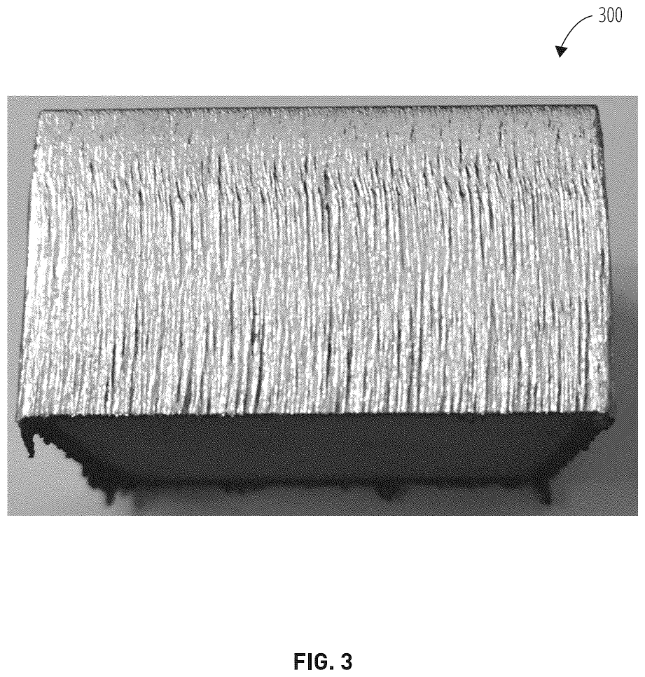

In contrast to FIG. 2, FIG. 3 shows a metal workpiece material 300 subjected to an improved cutting process. This process uses a dynamic focus adjustment of a laser beam in which the focus is rapidly moved vertically through the thickness of the material undergoing the cut. In this example, metal workpiece material 300 is about 16 mm, the profile of the cut is relatively smooth throughout the thickness, and there is less dross at a cutting speed of 0.4-0.8 m/min. By dynamically varying or oscillating the focus plane during processing improves the cutting parameters such as edge quality, reduction in dross, the smoothness of the edge, roughness, and linear speed.

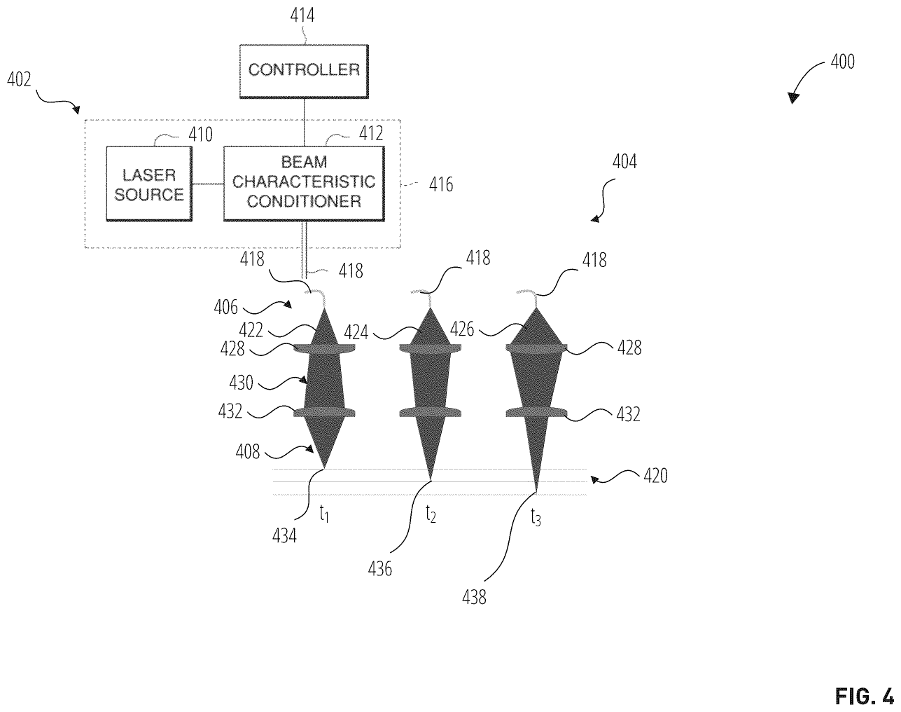

FIG. 4 shows a laser processing system 400, which includes an optical beam delivery device 402 and a process head 404. Optical beam delivery device 402 generates a variable divergence laser beam 406 that, when coupled to process head 404, provides the dynamic focus adjustment of an output laser beam 408, in accordance with examples described herein.

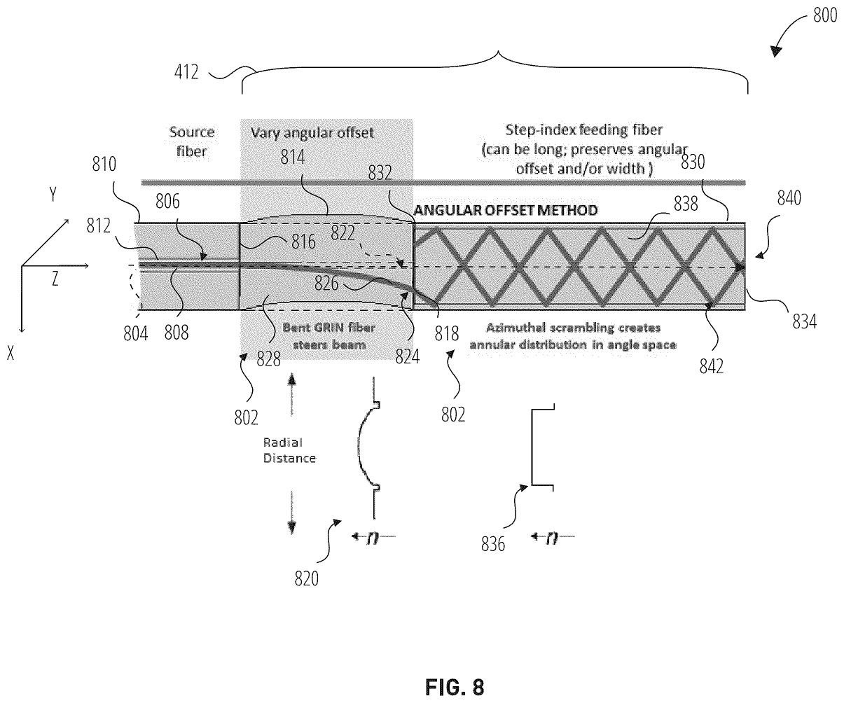

Optical beam delivery device 402 includes a laser source 410, a beam characteristic conditioner 412, and a controller 414. As described in the '567 patent, laser source 410 and beam characteristic conditioner 412 are components of a fiber assembly 416. Laser source 410, which may be a step-index feeding fiber or other type of optical fiber, provides an input laser beam (not shown) that is coupled to beam characteristic conditioner 412. Beam characteristic conditioner 412 includes first and second lengths of fiber operable to provide variable divergence laser beam 406. Examples of beam characteristic conditioner 412 are shown and described later with reference to FIG. 8-FIG. 10.

Controller 414 facilitates a selection of an amount of perturbation applied to beam characteristic conditioner 412 so as to vary the divergence of variable divergence laser beam 406 that is guided to process head 404. Various types of perturbation devices are shown in FIG. 24 of the '597 patent and include micro-bends, acoustic-optic transducer, and piezo electric device. Divergence structures (configured to modify divergence in response to perturbation) are shown in FIGS. 14B and 20 of the '597 patent.

A delivery fiber 418 from beam characteristic conditioner 412 may be routed directly to process head 404 or workpiece 420. In other embodiments, delivery fiber 418 may be routed to a fiber-to-fiber coupler (FFC) or fiber-to-fiber switch (FFS), which couples the light from delivery fiber 418 into a process fiber (not shown) that transmits the beam to process head 404 or the workpiece.

Process head 404 is shown operating at three different times: t₁, t₂, and t₃, which correspond to three different states of divergence of variable divergence laser beam 406. For instance, at time t₁, variable divergence laser beam 406 has a narrowest divergence 422 corresponding to a first amount of perturbation applied to beam characteristic conditioner 412. At time t₂, variable divergence laser beam 406 has an intermediate divergence 424 corresponding to a second amount of perturbation applied to beam characteristic conditioner 412. And at time t₃, variable divergence laser beam 406 has a widest divergence 426 corresponding to a third amount of perturbation applied to beam characteristic conditioner 412.

As variable divergence laser beam 406 is applied to a collimating lens 428 at the non-deal distance, variable divergence laser beam 406 is directed as an intermediate beam 430 to a focusing lens 432. Intermediate beam 430, however, has different angular and intensity distributions at a focusing lens 432 depending on the input divergence from delivery fiber 418 and the offset of collimating lens 428 from the ideal collimation distance. Accordingly, as focusing lens 432 focuses intermediate beam 430 at time t₁, t₂, and t₃, a focal point is moved down (or up) the beam axis for focusing at, respectively, a first material depth 434 (e.g., atop an upper surface of a workpiece 420 shown as a cross-section), a second material depth 436 (e.g., at an intermediate depth in the workpiece), and a third material depth 438 (e.g., at a lowest point in melt pool of the workpiece). The depths of the output laser beam 408 may be discrete depths or output laser beam 408 may be continuously transitioned between the depths. Furthermore, the depths may be reciprocated (e.g., rapidly adjusted) between shallow and deep depths as output laser beam 408 translates laterally relative to the workpiece. As output laser beam 408 is cutting workpiece 420, the focus is moving up and down rapidly such that the highest intensity is at the focus beam, and that intensity is moved throughout the material.

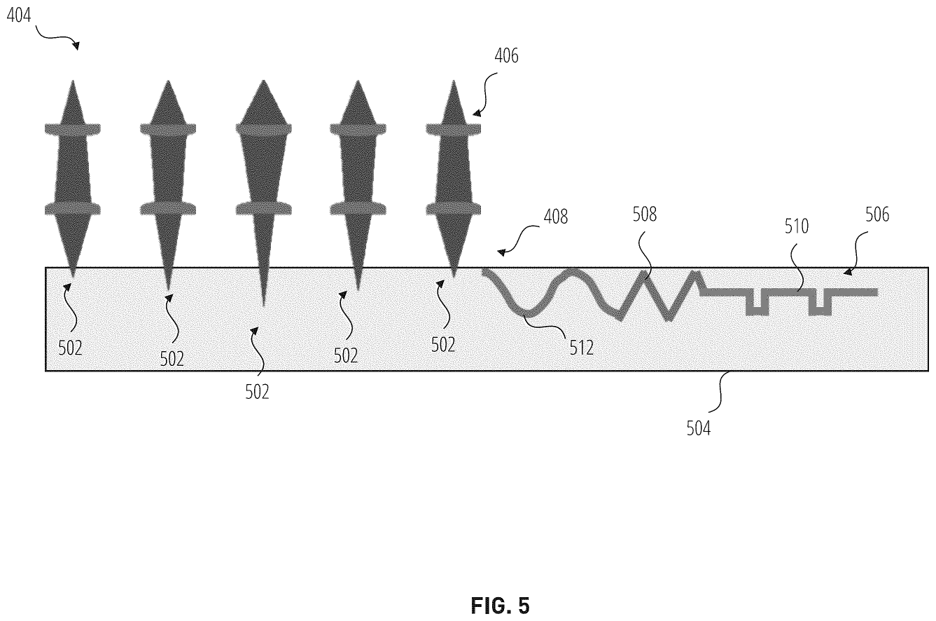

FIG. 5 shows on the right and left sides, respectively, examples how process head 404 has its focus positions 502 adjusted vertically over time as it moves relative to a workpiece 504, and examples of different resulting process paths 506 in or on workpiece 504. For instance, the frequency of focus position 502 can be adjusted in the range of 1 Hz to 10 kHz. When this vertically oscillating focus position 502 is combined with the travel speed of the cutting or welding process, in the range of 0.1 m/min to 500 m/min, the focus depth of the beam over the translation of the material is designed to match any repeating or arbitrary waveform used to optimize the process. This synchronization of focus and process speed results in a sawtooth 508 or triangle waveform for keyhole welding to maintain constant opening or closing condition of the keyhole vapor cavity. For cutting, this waveform can be a square wave 510 alternating between high and low focus to optimize the cut front and kerf width in the material. Other shapes, such as a sinusoidal shape 512, are also possible. In this example, the wavelength is on the order of microns to millimeters.

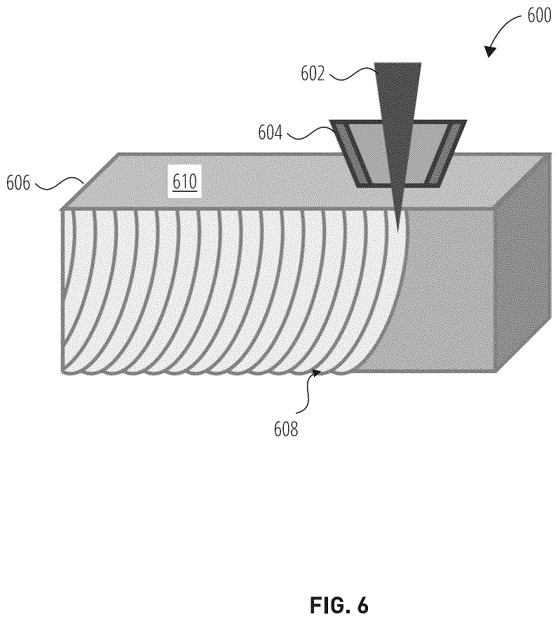

FIG. 6 shows an example of a laser cutting process 600. A laser beam 602 melts and vaporizes some of the base material in the beam path, while compressed gas delivered from a coaxial nozzle 604 ejects the melted material from the cut kerf. As described previously, laser beam 602 has the location of its intensity vertically reciprocated as laser beam 602 moves laterally to cut through a metal workpiece 606. The oscillating laser leaves striations on a cut edge 608 with a pattern caused by the processing variables. The vertical displacement of laser beam 602 relative to a top surface 610 of workpiece 606 is in a range of +30 mm to −50 mm so as to optimize material ejection, edge finish, and speed by regulating the dynamics of the absorption, melting, and ejection of the material from the kerf. In some embodiments, workpiece 606 has a thickness ranging from 3 mm to 100 mm. The frequency of the vertical reciprocation is in the thousands of Hz, such as 2,000 Hz. The cutting speed is typically ranging from 1 meter/min to 500 meters/min, in some embodiments.

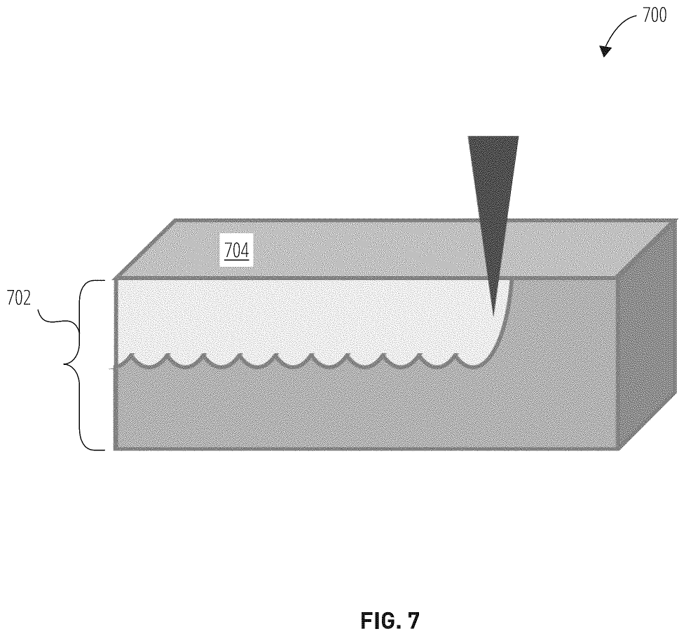

FIG. 7 shows an example of a laser welding process 700 that is partially penetrating the full material thickness 702. In this example, the vertical displacement relative to a top surface 704 is in a range of +10 mm to −10 mm to regulate the liquid/gas dynamics of the keyhole vapor cavity. The thickness of the material can vary, for example, from 3 mm to 30 mm. The variable focus welding process can be designed for complete joint penetration (not shown) or partial penetration welding. The frequency of the vertical focus reciprocation is in the hundreds of Hz (e.g., 10 Hz to 1,000 Hz). The welding speed would typically range from 1 meter/min to 30 meters/min, in some embodiments.

FIG. 8 shows an optical beam delivery device 800, which includes an embodiment of beam characteristic conditioner 412. In this example, optical beam delivery device 800 includes multiple lengths of optical fiber 802 arranged along an optical axis 804 and configured to generate variable divergence laser beam 406 by modifying a divergence distribution 806 of an input beam 808.

In one embodiment of FIG. 8, input beam 808 is delivered from a source fiber 810 having a step-index core 812. In other embodiments, a source fiber is a ring fiber (e.g., one or more annular cores surrounding an optional central core), and the ring fiber may be a component of beam characteristic conditioner 412 as described in the '597 patent. The term source fiber is any fiber (feeding or process) providing an input beam and that is fiber coupled (e.g., spliced) to a beam characteristic conditioner 412. The term fiber coupled (or couplable) includes a direct physical connection as well as connections that are slightly spaced apart, i.e., at or within one Rayleigh range, which is the distance along the propagation direction of a beam from the waist to the place where the area of the cross section is doubled.

Source fiber 810 is spliced to a first length of optical fiber 814, which has a first input 816 and a first output 818. Thus, first input 816 is coupled to a source fiber 810 and is configured to receive therefrom input beam 808 that is azimuthally symmetric with respect to optical axis 804.

First length of optical fiber 814 has a first RIP 820. First RIP 820 is configured to produce, in response to a controllable perturbation (e.g., macro-bending), a change in divergence distribution 806 from a first divergence distribution 822 corresponding to input beam 808 to a second divergence distribution 824 corresponding to a modified beam 826 at first output 818.

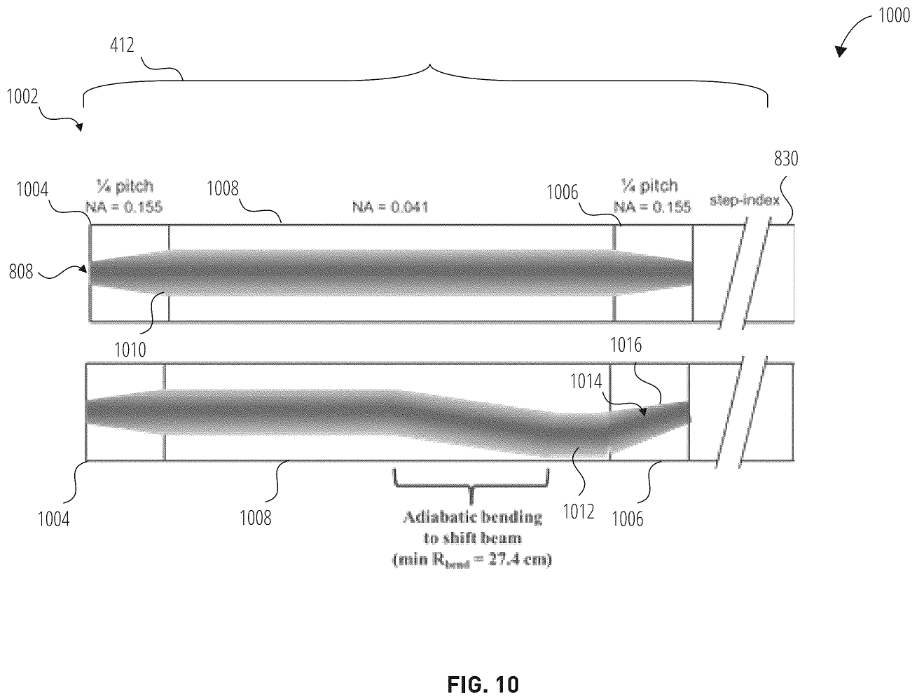

In the example of FIG. 8, first length of optical fiber 814 is a relatively short (e.g., less than 10 mm) GRIN fiber having a ¼-pitch length. At this length, input beam 808 beam reaches its maximum diameter, which is less than a 300 μm diameter GRIN core 828 in some embodiments. In other embodiments, an initial GRIN optical fiber segment may have a length of about ¼-pitch+N*½ pitch, where N equals zero or any positive integer. Other lengths are also possible, depending on the desired application (see, e.g., FIG. 10). In a GRIN fiber, light rays transmit along sinusoidal paths. The length of fiber corresponding to one sine wave period is called the pitch, defined as follows:

$$p = \frac{2 π}{\sqrt{k}} ,$$

where k is the gradient constant determined by the refractive index profile of the GRIN fiber. The refractive index profile of the GRIN fiber is defined as set forth in W. J. Smith, Modern Optical Engineering, Third Edition, McGraw-Hill, Inc. (2000), p. 286:

$$n ( r ) = {n}_{0} ( 1 - ( \frac{k}{2} ) {r}^{2} ) ,$$

where n₀ is the axial refractive index of the GRIN fiber.

In some embodiments, first length of optical fiber 814 and an initial section of a second length of optical fiber 830 are bent a variable amount (or not at all) around a mandrel (not shown) or other perturbation device shown and described in FIG. 24 of the '597 patent. Divergence distribution 806 of input beam 808 beam is thereby varied by changing its angular offset without necessarily affecting its width. For instance, first divergence distribution 822 has negligible angular offset with respect to optical axis 804 when first length of optical fiber 814 is not perturbed (i.e., straight, as indicated by dashed lines on first length of optical fiber 814) whereas second divergence distribution 824 includes a relatively large angular offset when first length of optical fiber 814 is perturbed (e.g., bent, as indicated in FIG. 8).

Second length of optical fiber 830, which includes a second input 832 and a second output 834, is coupled to first output 818 and configured to receive therefrom modified beam 826. Second length of optical fiber 830 has a step-index RIP 836 configured to preserve second divergence distribution 824. Modified beam 826 enters a step-index fiber core 838 (e.g., core diameter of 300 μm) and propagates while substantially preserving the angular offset with respect to optical axis 804. Second divergence distribution 824 is preserved, i.e., its ray angles relative to optical axis 804 (i.e., the fiber core) remain substantially constant from second input 832 to second output 834. Although it is largely preserved, for purposes of clarity (and recognizing that there may be some minor variation in the distributions) this disclosure refers to second divergence distribution 824 at second output 834 as a preserved angular intensity distribution 840.

In some embodiments, second length of optical fiber 830 may be about five meters to about 50 meters long so as to transport modified beam 826 a significant distance from the source (e.g., to a processing head or tool). As modified beam 826 travels through second length of optical fiber 830, second divergence distribution 824 is azimuthally averaged (i.e., smoothed or symmetrized) due to normal routing (coiling or bending) of this delivery fiber. Thus, phi ray angles (azimuthal) are assumed to be scrambled in second length of optical fiber 830. The angular width of input beam 808 results from rays having slightly different angles. These rays take different paths (generally helical) and end up being scrambled azimuthally (cylindrically symmetric, phi invariant).

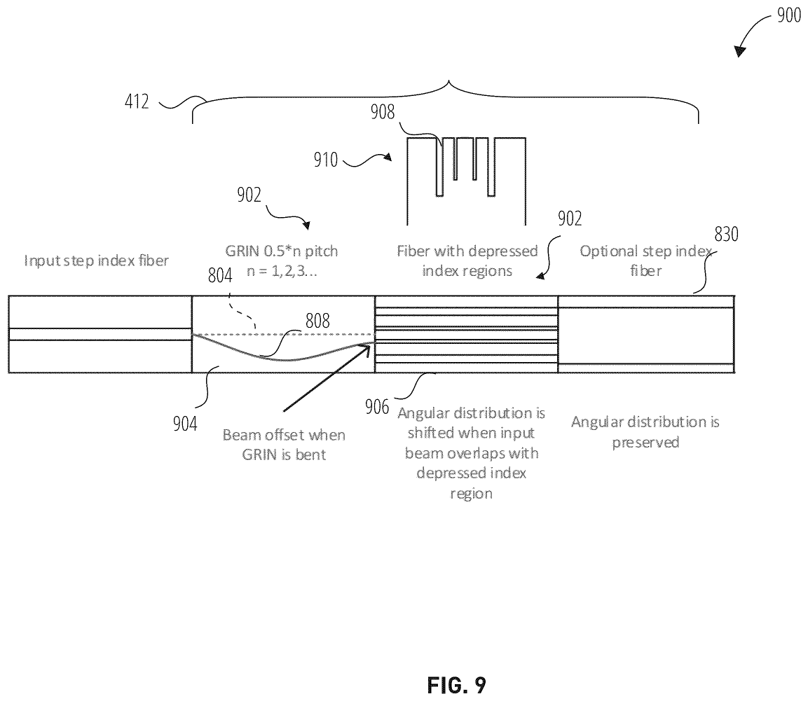

In another embodiment, FIG. 9 shows an optical beam delivery device 900, which includes an embodiment of beam characteristic conditioner 412. A first length of optical fiber 902 includes a first portion 904 and a second portion 906 coupled to first portion 904. First portion 904 includes a GRIN optical fiber segment having a length of about N*½ pitch, where N is any positive integer. Other lengths are also possible, depending on the design, but the length of about N*½ pitch facilitates interaction of the beam with low-index divergence structures 908 in second portion 906. Divergence structures 908 (shown in RIP 910) are designed to increase divergence. When first portion 904 is perturbed, input beam 808 is displaced from optical axis 804 so that it is incident upon at least one of divergence structures 908, which increases divergence to provide a modified beam to second length of optical fiber 830.

FIG. 10 shows another embodiment of an optical beam delivery device 1000, which includes another embodiment of beam characteristic conditioner 412. A first length of fiber 1002 has an input GRIN portion 1004, an output GRIN portion 1006, and a central GRIN portion 1008 therebetween. Input GRIN portion 1004 is configured to collimate input beam 808 to provide a collimated beam 1010. Central GRIN portion 1008 is configured to shift collimated beam 1010 in response to controllable perturbation (e.g., bending, as shown in bottom diagram of FIG. 10) so as to provide a shifted beam 1012. Output GRIN portion 1006 is configured to focus shifted beam 1012 to provide modified beam 826 having an angular offset 1014 and produce a divergence distribution that is different from that of input beam 808. For instance, by employing different NAs for input GRIN portion 1004 and output GRIN portion 1006, the angular width (divergence) may also be tuned. Input GRIN portion 1004 and output GRIN portion 1006 are each shown as having ¼-pitch length, but other lengths are also possible. The effective focal length of these segments may be designed to provide different divergences of modified beam 1016 or to change other beam properties to accommodate the desired use case. In contrast to ¼- or ½-pitch lengths described previously for first length of optical fiber 814 (FIG. 8), optical beam delivery device 1000 also provides an example of how first length of fiber 1002 may have varied lengths for different applications.

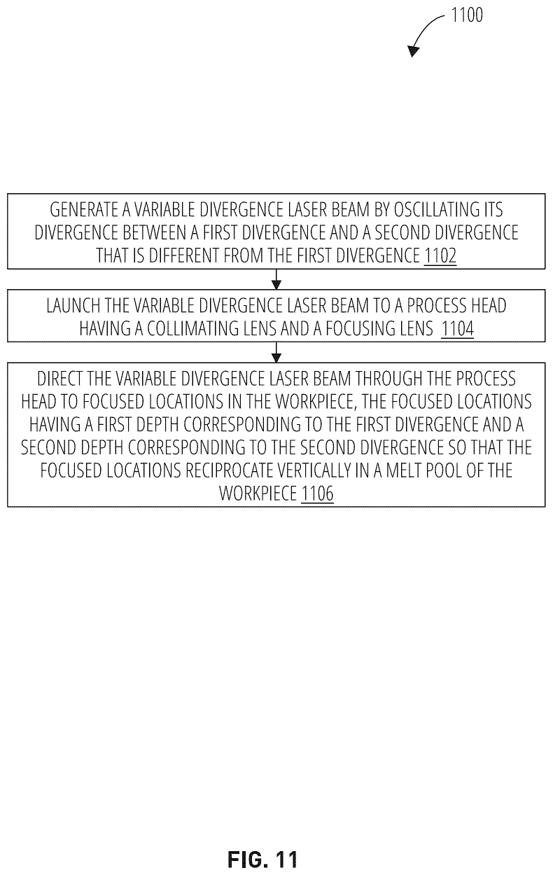

FIG. 11 shows a process 1100 for material processing a workpiece with a laser. In block 1102, process 1100 generates a variable divergence laser beam by oscillating its divergence between a first divergence and a second divergence that is different from the first divergence. In block 1104, process 1100 launches the variable divergence laser beam to a process head having a collimating lens and a focusing lens. In block 1106, process 1100 directs the variable divergence laser beam through the process head to focused locations in the workpiece, the focused locations having a first depth corresponding to the first divergence and a second depth corresponding to the second divergence so that the focused locations reciprocate vertically in a melt pool of the workpiece.

Process 1100 may further includes perturbing a divergence-tuning beam characteristic conditioner for generating the variable divergence laser beam. Process 1100 may also include micro-bending or macro-bending.

Process 1100 may also include the divergence-tuning beam characteristic conditioner having first and second lengths of fiber with different RIPs. A first RIP of the first length of fiber is configured to cause a change in a divergence distribution that is preserved by the second fiber having a second RIP.

Process 1100 may also include changing a frequency of the oscillating based on material type of the workpiece (e.g., metal, glass, ceramic, plastic, or other type), based on thickness of the workpiece, or based on a type of the laser process (e.g., cutting, welding, or other process).

Having described and illustrated the general principles of examples of the presently disclosed technology, it should be apparent that the examples may be modified in arrangement and detail without departing from such principles. Skilled persons, therefore, will appreciate that many changes may be made to the details of the above-described embodiments without departing from the underlying principles of the invention. The scope of the present invention should, therefore, be determined only by the following claims.

What is claimed is:

1. A laser processing system for material processing a workpiece with a laser, comprising:
a fiber assembly including a laser source and a divergence-tuning beam characteristic conditioner configured to, in response to a control input, repetitively change a variable divergence laser beam between a first divergence and a second divergence that is different from the first divergence;
a process head having a collimating lens and a focusing lens; and
a delivery fiber coupled to the divergence-tuning beam characteristic conditioner for guiding the variable divergence laser beam and launching it to the process head,
in which the collimating lens is configured to receive the variable divergence laser beam and direct it as an intermediate beam to the focusing lens, and in which the focusing lens is configured to focus the intermediate beam toward the workpiece at a first depth corresponding to the first divergence and at a second depth corresponding to the second divergence so that a focused location reciprocates vertically in a melt pool of the workpiece.

2. The laser processing system of claim 1, in which the divergence-tuning beam characteristic conditioner is configured to repetitively change the variable divergence laser beam by oscillating between the first and second divergences.

3. The laser processing system of claim 1, in which the divergence-tuning beam characteristic conditioner is configured to repetitively change the variable divergence laser beam by discrete switching between the first and second divergences.

4. The laser processing system of claim 1, in which the divergence-tuning beam characteristic conditioner is further configured to repetitively change the variable divergence laser beam between the first divergence and the second divergence utilizing a constant beam power between the first divergence and the second divergence.

5. The laser processing system of claim 1, in which the divergence-tuning beam characteristic conditioner is further configured to repeatedly change the variable divergence laser beam between the first divergence and the second divergence by, selectively, using one or more frequencies in a first frequency range for welding metal or in a second frequency range for cutting metal.

6. The laser processing system of claim 5, in which the one or more frequencies of the second frequency range are higher frequencies than the one or more frequencies of the first frequency range.

7. The laser processing system of claim 5, in which:
the first frequency range comprises frequencies of approximately 10 Hertz to 1,000 Hertz; and
the second frequency range comprises frequencies of approximately 1,000 Hertz to 5,000 Hertz.

8. The laser processing system of claim 1, in which the divergence-tuning beam characteristic conditioner includes a first and second length of fiber having different RIPs.

9. The laser processing system of claim 1, further comprising a mandrel for perturbing the divergence-tuning beam characteristic conditioner.

10. The laser processing system of claim 1, further comprising a micro-bend section for perturbing the divergence-tuning beam characteristic conditioner.

11. The laser processing system of claim 1, in which the material processing is a cutting or welding process.

12. The laser processing system of claim 1, in which the workpiece is metal.

13. A method for material processing a workpiece with a laser, the method comprises:
generating a variable divergence laser beam by oscillating its divergence between a first divergence and a second divergence that is different from the first divergence;
launching the variable divergence laser beam to a process head having a collimating lens and a focusing lens; and
directing the variable divergence laser beam through the process head to focused locations in the workpiece, the focused locations having a first depth corresponding to the first divergence and a second depth corresponding to the second divergence so that the focused locations reciprocate vertically in a melt pool of the workpiece.

14. The method of claim 13, further comprising perturbing a divergence-tuning beam characteristic conditioner for generating the variable divergence laser beam.

15. The method of claim 14, in which the perturbing comprising micro-bending or macro-bending.

16. The method of claim 15, in which the divergence-tuning beam characteristic conditioner includes first and second lengths of fiber having different RIPs, a first RIP of the first length of fiber causing a change in a divergence distribution that is preserved by the second fiber having a second RIP.

17. The method of claim 13, further comprising changing a frequency of the oscillating based on material type of the workpiece.

18. The method of claim 13, further comprising changing a frequency of the oscillating based on thickness of the workpiece.

19. The method of claim 13, further comprising changing a frequency of the oscillating based on a type of the laser process.

20. The method of claim 13, in which the material processing is a cutting or welding process.
